(19) United States
(12) Patent Application Publication
(10) Pub. No.: US 2018/0063053 A1
(43) Pub. Date: Mar. 1, 2018

(54) GUSTOTARY MESSAGE PROCESSING SYSTEM AND METHOD

(71) Applicant: Flavour Message AG, Zug (CH)

(72) Inventors: Jörg Rychen, Zürich (CH); Dominik Thomann, Zürich (CH)

(21) Appl. No.: 15/555,301

(22) PCT Filed: Mar. 2, 2016
(86) PCT No.: PCT/EP2016/054474

§ 371 Date: Sep. 1, 2017

(30) Foreign Application Priority Data
Mar. 6, 2015 (CH) 00309/15

(51) Int. Cl. H04L 12/58; A23P 20/10

(52) U.S. Cl. CPC H04L 51/10; H04L 51/18; A23P 2020/253; H04L 51/32; A23P 20/10

(57) ABSTRACT

The present invention relates to a system and a method for transmitting and producing a taste. The system comprises a first electronic device configured to transmit a taste message, wherein the taste message includes a taste recipe defining a composition of a plurality of taste substances, a second electronic device configured to receive the taste message and to transmit the taste recipe, a controller configured to read the taste recipe, and a taste generator configured to generate the composition of the taste substances defined by the taste recipe on a carrier wherein the taste generator is controlled by the controller.

### BACKGROUND

The present invention relates to a gustatory message system. More specifically, the invention relates to a system and a method to receive a gustatory message which identifies gustatory substances to be included in a gustatory product and to generate the gustatory product.

Electronic messaging including instant message, personal message, text message, e-mail is widely used for personal communication, commercial communication, social network ect. The traditional postal messaging is more and more replaced by the electronic messaging, since the electronic message can be transmitted very quickly, and besides the text information, the information in different forms, such as pictures, videos, and audio information can be transmitted by the electronic messaging.

Recently, systems and methods to transmit the sensory information such as, odor and taste have been developed in order to increase the substantial experiences of the users.

For example, a special odor can be sent to a user and can be generated in the close proximity of the user. In this way, a visual sensing and an olfactory sensing can be perceived by the user at the same time.

WO 2005/048541 describes an apparatus and method for transmitting synchronized five senses and a system providing an actual-feeling multimedia data. The five sensory synchronizing and transmitting apparatus forms packets by describing vibration, odour, and taste expressed in video/audio by using touch, odour and taste data descriptor, synchronizes touch/odour/taste packets with video/audio packets on a frame basis and transmitting the synchronized packets. The actual-feeling multimedia data providing system can provide an actual feeling multimedia service by demultiplexing the packets transmitted from the five sensory data synchronizing and transmitting apparatus and transmitting video data, audio data, touch data, odour data and taste data to corresponding devices.

WO 2014/186751 describes sensory messaging systems, which are configured to enable users to transmit sensory messages between sensory messaging devices. The recipients can experience substantially without having to read any text associated with the message. Sensory messages may include an odor, a spark, a vibration, a sound, a light or a warming.

### SUMMARY

It is an objective of this invention to provide a method and a system for processing a gustatory message, which overcome at least some of the drawbacks known from the prior art. In particular, it is an objective of this invention to provide an improved method and an improved system for enabling a user to substantially experience an real gustatory message transmitted as an electronic message. In particular, it is an objective of this invention to provide an improved method and an improved system for perceiving an electronic message using different senses, for example visual sense, gustatory sense, olfactory sense at the same time.

According to the present invention, these objectives are achieved through the features of the independent claims. In addition, further advantageous embodiments follow from the dependent claims and the description.

According to the present invention, the above mentioned objectives are particularly achieved in that a gustatory message processing system comprises a plurality of—preferably—eatable carrier elements, a plurality of gustatory substances, a generator and a controller. The generator is configured to modify one of the carrier elements such as to generate a gustatory product that comprises the carrier element and one or more of the gustatory substances. The controller is connected to the generator and configured to receive a gustatory message which identifies gustatory substances to be included in the gustatory product, and to control the generator to generate the gustatory product using the gustatory substances identified in the gustatory message.

In some embodiments, the system further comprises a sender configured to generate the gustatory message and transmit the gustatory message to the controller.

In a preferred embodiment, the system further comprises a sender and a receiver. The sender is configured to generate and transmit an electronic message including the gustatory message using electronic messaging application, such as SMS, MMS, Whatsapp, Facebook, and Twitter. The receiver is configured to receive the electronic message and transmit the gustatory message included therein to the controller.

In some embodiments, the generator is configured to add the gustatory substances into the carrier element for generating the gustatory product.

In some embodiments, the generator is configured to coat, deposit or print the gustatory element on the carrier element for generating gustatory product.

In some embodiments, the generator is configured to print the gustatory element on the carrier element using ink-jet printing, a thermal sublimation printing or a 3D printing.

Other possible implementations are gustatory application by micro-spray or mechanical deposition, preferably using one or more ribbons carrying the gustatory substance or substances as known from typewriters or needle printers.

In some embodiments, the generator is configured to activate one or more gustatory substances predefined on the carrier element for generating the gustatory product.

In some embodiments, the generator is configured to remove one or more gustatory substances predefined on the carrier element for generating the gustatory

In some embodiments the gustatory message processing system is configured to be a portable device. This has the advantage that a user may carry the system with him and generate a gustatory product anywhere. Preferably the portable device is not bigger than a pocket size device.

In some embodiments the gustatory message processing system or at least parts of it are configured to be a disposable unit or to comprise more than one disposable units. The disposable unit is preferably designed to allow the production of a multitude of gustatory products. Preferably only parts of the unit are disposable, for example one or several gustatory substance cartridges are disposable and replaced when empty. Further preferred is to store the carrier elements in a container or magazine which are reloadable or disposable. Consequently, a compact and cheap design can be achieved.

In preferred embodiments, the carrier is an eatable carrier, such as a sugar pill, a chewing gum and edible paper or any sugar replacement material and/or composition or a mixture of the aforementioned. By modifying the edible carrier elements by adding the gustatory substance or substances, a taste sensation is transferred to, made available to and finally experienced by a user when tasting the gustatory product. The user may substantially experience an electronic messaging with a sense hitherto not stimulated by electronic messaging systems. The system of the present invention benefits from both the advantages of electronic messaging such as fast, flexible and wide propagation and the advantages of substantial gustatory experience for the users.

The carrier element is preferably an edible material, however according to further embodiments of the present invention, the carrier element is not edible or ingestible but produced from a material not suitable for ingestion and used only to allow the user to lick or suck the gustatory substances from the carrier.

Beside a system, the invention concerns a gustatory message processing method comprising modifying by a generator one of a plurality of eatable carrier elements such as to generate a gustatory product that comprises the carrier element and one or more of a plurality of gustatory substances; receiving by a controller connected to the generator a gustatory message which identifies gustatory substances to be included in the gustatory product; and controlling the generator to generate the gustatory product using the gustatory substances identified in the gustatory message by the controller.

In a variant, the method further comprises generating by a sender the gustatory message and transmitting the gustatory message to the controller.

In a variant, the method further comprises generating and transmitting by a sender an electronic message including the gustatory message using electronic messaging application, such as SMS, MMS, Whatsapp, Facebook, Twitter; receiving the electronic message and transmitting the gustatory message included therein to the controller by a receiver.

In a variant, the generator is configured to add the gustatory substances into the carrier element for generating the gustatory product.

In a variant, the generator is configured to coat, deposit or print the gustatory substances on the carrier element for generating the gustatory product.

In a variant, the generator is configured to print the gustatory element on the carrier element using ink-jet printing or a thermal sublimation printing, or a 3D printing.

In a variant, the generator is configured to activate a part of the gustatory substances predefined on the carrier element for generating the gustatory product.

In a variant, the generator is configured to remove a part of the gustatory substances predefined on the carrier element for generating the gustatory product.

### BRIEF DESCRIPTION OF THE DRAWINGS

In order to describe the manner in which advantages and features of the disclosure can be obtained, in the following a more particular description of the principles briefly described above will be rendered by reference to specific embodiments thereof which are illustrated in the appended drawings. These drawings depict only exemplary embodiments of the disclosure and are not therefore to be considered to be limiting of its scope. The principles of the disclosure are described and explained with additional specificity and detail through the use of the accompanying drawings in which:

FIG. 1 illustrates a gustatory message processing system;

FIG. 2 illustrates one embodiment of the system including a sender;

FIG. 3 illustrates another embodiment of the system including a sender and a receiver;

FIG. 4 illustrates one embodiment of the system, in which a gustatory message application is installed in the sender;

FIG. 5 illustrates a schematic of a graphical user interface included in the gustatory message application to generate a gustatory message;

FIG. 6 illustrates a schematic of a graphical user interface of included in the gustatory message application to open the gustatory message;

FIG. 7 illustrates one embodiment of the system as a portable device;

FIG. 8 illustrates one embodiment of the system comprising a plurality of additional gustatory substance cartridges;

FIG. 9 illustrates a variant of generating a gustatory product by activating one or more predefined gustatory substances on a carrier element;

FIG. 10 illustrates a variant of generating the gustatory product by removing one or more predefined gustatory substances on the carrier element; and

FIG. 11 illustrates steps performed in a gustatory message processing method.

### DESCRIPTION

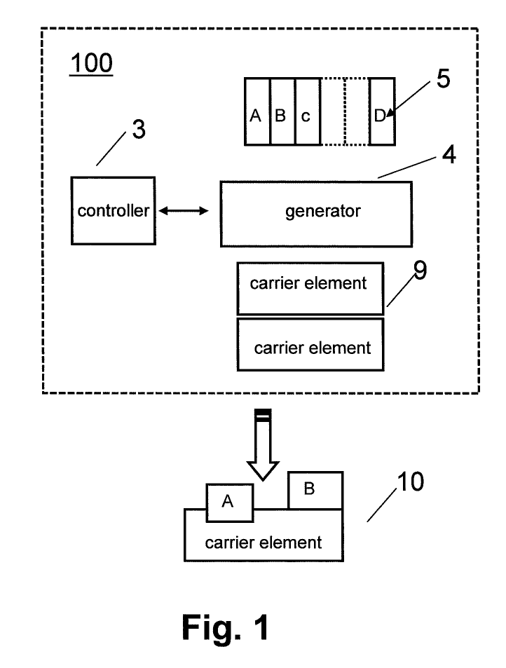

FIG. 1 illustrates a gustatory message processing system 100 according to the present invention. The system 100 comprises a plurality of eatable carrier elements 9, a plurality of gustatory substances 5, a generator 4 and a controller 3. In FIG. 1, symbols A, B, C and D illustrate different gustatory substances for example, strawberry, chocolate, mint and basil respectively. The generator 4 can modify one of the carrier elements such as to generate a gustatory product 10 that comprises the carrier element and one or more of the gustatory substances. The controller is connected to the generator and can receive a gustatory message which identifies gustatory substances to be included in the gustatory product, and control the generator to generate the gustatory product using the gustatory substances identified in the gustatory message. As illustrated in FIG. 1, the gustatory message received by the controller identifies for example two gustatory substances A and B. The skilled person in the art will understand that the gustatory message includes also dosage information of each gustatory substance to be included in the gustatory product. The controller 3 controls the generator 4 to modify the carrier element 9 and generate the gustatory product 10 including the carrier element and the gustatory substances A and B with the defined dosage.

In a preferred variant, the carrier element 9 is an edible carrier, such as a sugar pill, a chewing gum, an edible stack, and eatable paper. The gustatory substances may be gustatory such as strawberry, banana, chocolate, mint, ect. In a further variant, the gustatory substances comprise medical substances, or pharmaceutical substances which may be used for treating certain disease, for example headache, sleeping disturbance.

In addition to the gustatory substances edible food colouring can be added by the generator to colour the carrier element according to the information in the message.

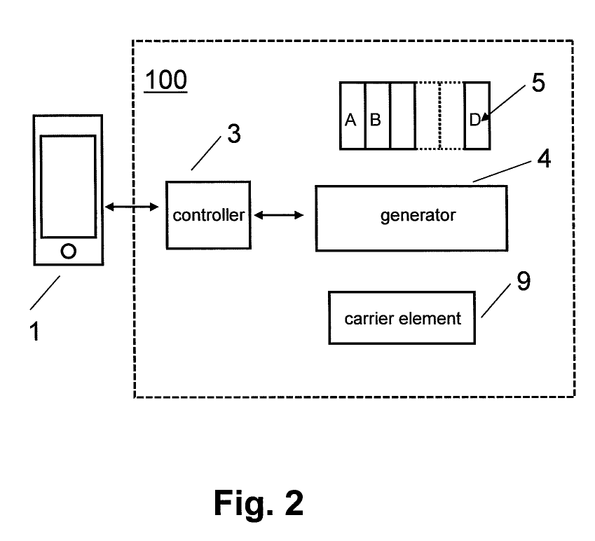

FIG. 2 illustrate on embodiment of the system, which further comprises a sender 1. The sender 1 may generate a gustatory message and transmit the gustatory message to the controller 4 over a communication such as Bluetooth, WLAN, GSM or UMTS. The sender 1 may be a computerized device e.g. personal computer, tablet computer, or a mobile communication device, e.g., mobile phone, smart phones. As will be described later in more detail, a gustatory message application is installed in the sender 1 and is applied to generate the gustatory message. In this case, a user may generate a gustatory product and taste it before sending a gustatory message to another user.

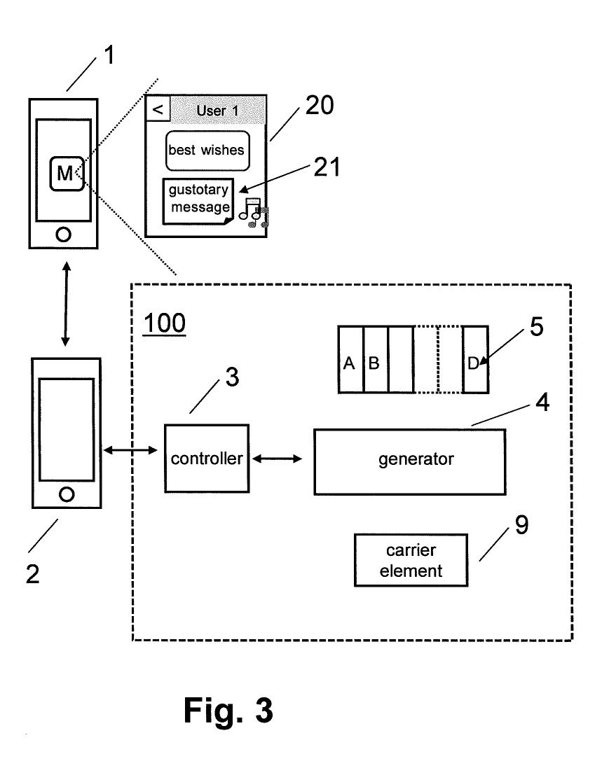

FIG. 3 illustrates one embodiment of the system, which further comprises a sender 1 and a receiver 2. The sender 1 and the receiver 2 may be a computerized device e.g. personal computer, tablet computer, or a mobile communication device, e.g., mobile phone, smart phones. The sender 1 can communicate with the receiver 2 over one or multiple communication networks. The communication networks can be, the Internet, a cellular network, a local area network (LAN), a wide area network (WAN), a Wi-Fi network or a combination thereof.

A user can utilize an electronic messaging application, such as SMS, MMS, Email, WhatsApp, Facebook, Twitter, etc. to generate an electronic message 20 including gustatory, odour, pattern, text, video, audio information. The gustatory information may be presented in a gustatory message 21, which identifies gustatory substances to be included in a gustatory product. It should be understood that the gustatory message 21 encompasses information, the kind of gustatory substance and the dosage of each gustatory substance. The gustatory message 21 may be included in the electronic message 20 with or without further information, for example, a text, a picture, a video, music, or a ring ton for a mobile phone. The electronic message 20 may be transmitted to the receiver 2 over one or multiple communication networks.

In a preferred embodiment of the electronic message the gustatory information (substances and dosage) can be embedded in a picture either visible (e.g. by adding a QR code) or invisible by adding a water mark containing the gustatory information.

The receiver 2 may send the gustatory message 21 to a controller 3, which activates and controls the generator 4 to generate the gustatory product using the gustatory substances identified in the gustatory message 21. The controller 3 may be a software module or a hardware module or a combination thereof.

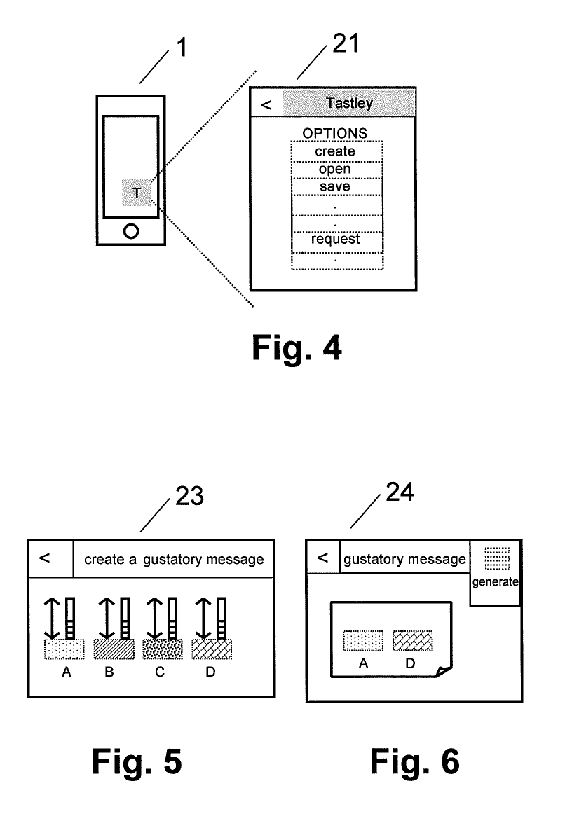

As mentioned above and illustrated in FIG. 4, a user may generate a gustatory message 21 by using a gustatory message application 22, which may be installed in a sender, in a receiver and in a controller. The gustatory message application 22 may provide for example the following options: create a gustatory message, open a gustatory message, display a gustatory message, edit a gustatory message, save a gustatory message, forward a gustatory message, and request gustatory message, request and display information related to a generator 4.

In this way, a user may create an individual gustatory message 21, open a saved or received gustatory message 21 and edit it. Furthermore, a received gustatory message 21 may be forwarded to another electronic device. Moreover, one electronic device having the gustatory message application installed may send a request to an electronic device or a server for obtaining a gustatory message, which may be sent back to the electronic device sending the request or directly to another electronic device.

In addition, the receiver 1 may request information related to the generator 4, for example the status of the generator 4, from the receiver 2 via a communication protocol e.g. request-answer techniques. To achieve this, the sender 1 sends a request to the receiver 2, the receiver 2 forwards the request to the controller 3, in which the information required is stored. The requested information is then sent from the controller 3 to the receiver 4 and further forwarded to the sender 1.

The gustatory message application may include one or more graphical user interface to provide a user-friendly handling. FIG. 5 shows one of the graphical user interfaces. A first graphical user interface 23 enables a user to create or edit a gustatory message. The first graphical user interface 23 comprises e.g. bars, buttons, tabs, text boxes. For example, each bar illustrates one kind of gustatory substance, the dosage of each selected gustatory substance may be varied by changing the bars. The name of each gustatory substance is labelled below each bar with a text or a picture.

In another variant, the graphical user interface 23 includes tables or lists with the name of the gustatory substances and their dosage, which can be selected by the user to define the gustatory message.

The user graphical interface 23 is not limited to the variant explained above. Pictures may be displayed on the graphical user interface 23 and the user may choose the gustatory substances by clicking the corresponding pictures and entering the dosage of the selected gustatory substance text based or graphically. It is possible for the user to customize the first graphical user interface 23.

The gustatory message 21 can include one or more of the following information: substance, dosage, pattern, picture, text. This means, a text, a pattern or a picture can be generated with the gustatory substance on a carrier element. This allows according to further preferred embodiments to imprint the edible carrier element with a word, a logo, letters or images according to the message.

FIG. 6 illustrates a second graphical user interface 24, which enables a user to for example, to open a gustatory message, which identifies gustatory substances to be included in a gustatory product and generate the gustatory product. The second receiver 2 receives an electronic message transmitted from a sender. By selecting for example the option “generate”, the gustatory message is transmitted to a controller 3 to control the generator 4 to generate the gustatory product. In a variant, the gustatory message may in a first step be edited by for example deleting, a gustatory substance, adding a gustatory substance or changing the dosage of a gustatory substance before sent to the controller 4.

In a variant, the controller 4 reads the received gustatory message 21 and provides an indication, if the gustatory substances defined in the gustatory message are available for the generator and/or if additional gustatory substances should be supplied according to the received gustatory message. This indication may be displayed on a display of the receiver 2.

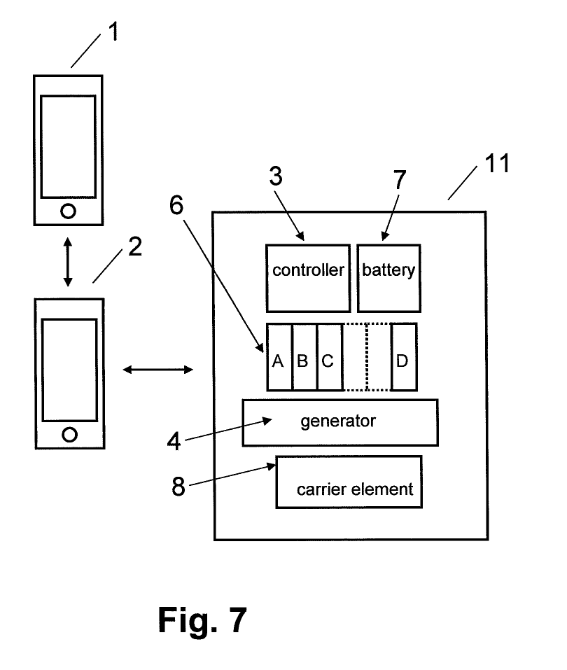

FIG. 7 shows one embodiment of the system that the gustatory system is configured to be a portable device, namely gustatory message processing device 11, to improve the flexibility of the system. The gustatory message processing device 11 includes a controller 3, a generator 4, a battery 7, a plurality of gustatory substance cartridges 6 and a carrier container 8 containing one or more carrier elements 9. The receiver 2 communicates with the gustatory message processing device 11 preferably over a wireless communication. The gustatory substance cartridges 6 containing a collection of gustatory substances provide the material to generate a gustatory product comprising the gustatory substances and the carrier element 9. The gustatory substance cartridges 6 may contain different gustatory substances or different intensity of each gustatory substance, therefore, a huge variation of the taste can be generated. In one variant, a standardized collection of the gustatory substances cartridge symbolized with A, B, C and D in FIG. 7 is arranged in gustatory message processing device 11 to meet the general need of the users. One or more carrier elements 9 are stored in the carrier container 8. Preferably, the carrier element is eatable with or without taste. The generator 4 serves for adding the gustatory substances to the carrier element 9. In one embodiment, the generator 4 is an ink-jet printer head, which coats the droplets of the gustatory substance to the carrier 9. If a user receives a gustatory message and wants to generate the gustatory product, he may select the option “generate” in the gustatory message application 22. By conducting this option, the gustatory recipe received is further transmitted to the controller 3, which adapts the gustatory message 21 and controls the printer head 4, so that the printer head 4 controls the corresponding gustatory substance cartridge 6 to release the gustatory substance stored with the defined dosage on the carrier element 9. FIG. 7 illustrates the embodiment, that the gustatory message processing device 11 is electrically supplied by a battery integrated in it. However, it should be understood, that its power supply may be provided in other manners, such as by connecting it to the receiver 2, or a power bank.

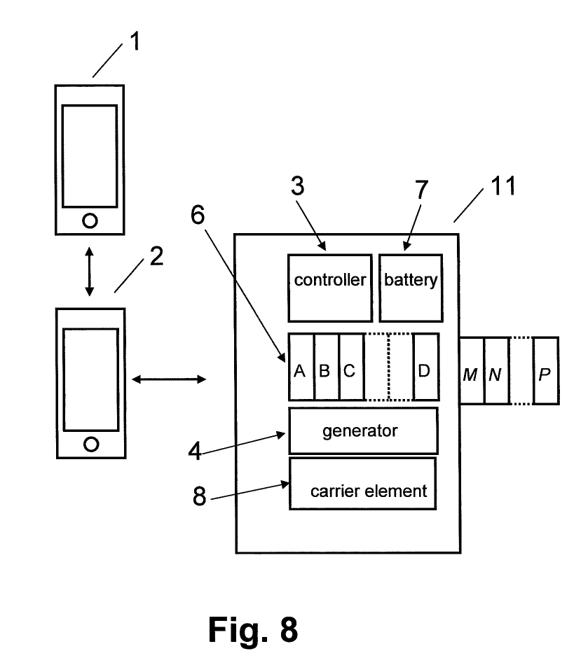

FIG. 8 illustrates another embodiment of the system, in which additional gustatory substance cartridges containing special gustatory substances are supplied to the generator 4, for example, spicy, bitter, herbage, and pharmaceutical. The additional gustatory substance cartridges are symbolized with M, N and P in FIG. 8. They may replace a part of the standardized gustatory substance cartridges 6 or are supplied additionally, by arranging them in the gustatory message processing device 11 or connecting them to it externally directly or through a connecting mean. In a variant, the standardized gustatory substance cartridges 6 and the carrier container 8 are removable connected the gustatory message processing device 11 directly or through a connecting mean.

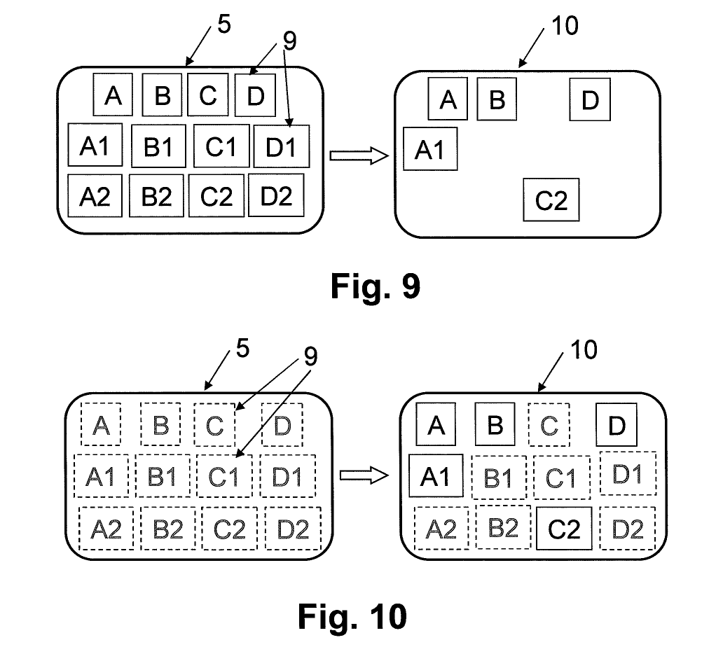

In the embodiment of FIG. 7 an ink-jet printing principle is applied to generate the gustatory product. However, the person skilled in the art should understand that, other working principles to generate the gustatory product may also be used, for example, thermal sublimation printing, micro valve printing, or 3D printing. FIG. 9 and FIG. 10 illustrate two further working principles.

FIG. 9 illustrates a working principle by removing one or more gustatory substances predefined on a carrier element 9. This means, the carrier element comprises a plurality of predefined gustatory substances 5. For example, the patches A1, B1, C1, and D1 symbolise gustatory substances for chocolate, strawberry, mint and chamomile flavour deposited with a dosage of 1 mg on the carrier element. The patches A2, B2, C2, and D2 symbolise the same gustatory substances for chocolate, strawberry, mint and chamomile flavour with a higher dosage of 5 mg. The patches A3, B3, C3, and D3 symbolise gustatory substances for chocolate, strawberry, mint and chamomile flavour with an even higher dosage of 50 mg. According to the gustatory message, the controller 3 controls deactivating means to remove and/or deactivate the gustatory substances, which are not identified in the gustatory message.

FIG. 9 illustrates that the generated gustatory product 10 comprising the carrier element and a selection of remaining gustatory substances in patches A, B, D, A1, and C2. The removal of the gustatory substances may be conducted mechanically, for example by scratching or cutting or by deactivation. The predeposited patches of gustatory substances may be deactivated or destroyed thermally, for example by using laser technology or electrically. The achieved gustatory product 10 is

FIG. 10 illustrates a further working principle according to the present invention. One or more gustatory substances predefined on the carrier element 5′, preferably predeposited in spatially clearly defined patches 9′, are activated. For example, the symbols A1, B1, C1, and D1 symbolise patches comprising gustatory substances for the following flavours:

chocolate, strawberry, mint and chamomile with a dosage of 1 mg. The elements A2, B2, C2, and D2 symbolise patches with the same gustatory substances with a second dosage of for example 5 mg. The elements A3, B3, C3, and D3 symbolise patches with similar substances with a third dosage of for example 2.5 mg. According to the gustatory message, the controller controls an activating mean to activate the gustatory substances, which are identified in the gustatory message. FIG. 10 illustrates for example the generated gustatory product 10′ includes the carrier element and gustatory substances A, B, D, A1, C2. The predeposited gustatory substances can be activated mechanically, chemically, thermally, optically or electrically.

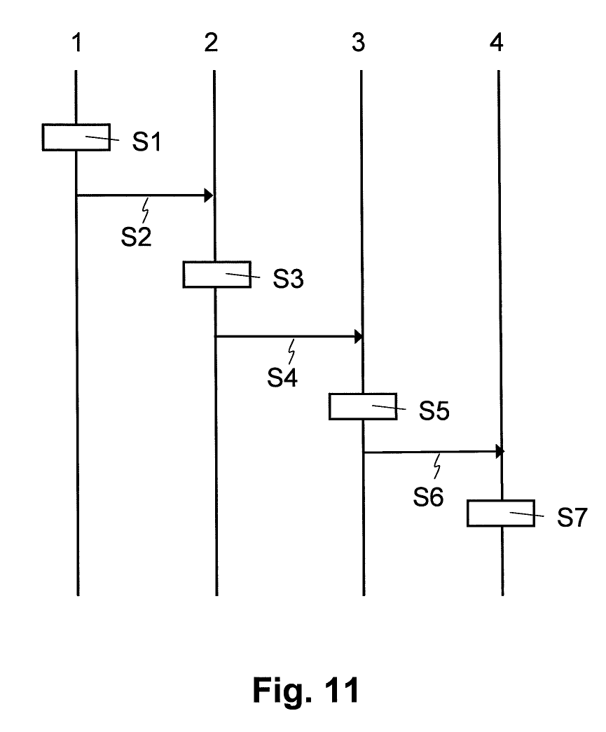

FIG. 11 illustrates one embodiment of a gustatory message processing method. In step S1, a user generates an electronic message including a gustatory message. Steps of requesting a gustatory message from a computerized device and receiving the gustatory message may be or may be not included in the step S1. In step S2, the electronic message is transmitted to a receiver 2. Furthermore, this step may include a step, that an electronic message is received from a computerized device directly upon request. In S3, the received electronic message is opened, edited, forwarded or saved. In step S4, as response to selecting the option “generate”, the gustatory message included in the electronic message is transmitted to a controller 3. In step S5, the controller 3 reads the received gustatory message. In step S6, the controller 3 sends the adapted gustatory to generator 4. In step S7, a gustatory product is generated by the generator, which is controlled by the controller 4.

1. A gustatory message processing system, comprising:
a plurality of carrier elements;
a plurality of gustatory substances;
a generator configured to modify a carrier element such as to generate a gustatory product that comprises the carrier element and one or more of the gustatory substances;
a controller connected to the generator and configured to receive a gustatory message which identifies gustatory substances to be comprised by the gustatory product, and to control the generator to generate the gustatory product using the gustatory substances identified in the gustatory message.

2. The system according to claim 1, wherein the system further comprises a sender configured to generate the gustatory message and to transmit the gustatory message to the controller.

3. The system according to claim 1, wherein the system further comprises:
a sender configured to generate and to transmit an electronic message including the gustatory message using an electronic messaging application, wherein the electronic messaging system is at least one of SMS, MMS, Whatsapp, Facebook, or Twitter; and
a receiver configured to receive the electronic message and transmit the gustatory message included therein to the controller.

4. The system according to claim 1, wherein the generator is configured to add the gustatory substances into the carrier element for generating the gustatory product.

5. The system according to claim 4, wherein the generator is configured to coat, deposit, or print the gustatory substances on the carrier element for generating the gustatory product.

6. The system according to claim 5, wherein the generator is configured to print the gustatory element on the carrier element using ink-jet printing, thermal sublimation printing, 3D printing, micro spraying, or mechanical deposition.

7. The system according to claim 1, wherein the generator is configured to activate one or more gustatory substances predefined on the carrier element for generating the gustatory product.

8. The system according to claim 1, wherein the generator is configured to remove one or more gustatory substances predefined on the carrier element for generating the gustatory product.

9. The system according to claim 1, wherein the gustatory system is configured to be a portable pocket-size device.

10. The system according to claim 1, wherein the parts of the gustatory system are configured to be reloadable or disposable.

11. The system according to claim 1, wherein the carrier element is an edible carrier, wherein the edible carrier is a sugar pill, a chewing gum, or at least one of an element formed from a sugar replacement material a composition, or a mixture of the aforementioned.

12. A gustatory message processing method, comprising:
modifying, by a generator, a carrier element to generate a gustatory product that comprises the carrier element and one or more of a plurality of gustatory substances;
receiving, by a controller connected to the generator, a gustatory message which identifies gustatory substances to be included in the gustatory product; and
controlling, by the controller, the generator to generate the gustatory product using the gustatory substances identified in the gustatory message.

13. The method according to claim 12, wherein the method further comprises generating, by a sender, the gustatory message and transmitting the gustatory message to the controller.

14. The method according to claim 12, wherein the method further comprises:
generating and transmitting, by a sender, an electronic message including the gustatory message using electronic messaging application; and
receiving, by a receiver, the electronic message and transmitting the gustatory message included therein to the controller.

15. The method according to claim 12, wherein the generator is configured to add the gustatory substances into the carrier element for generating the gustatory product.

16. The method according to claim 15, wherein the generator is configured to coat, deposit, or print the gustatory substance on the carrier element for generating the gustatory product.

17. The method according to claim 16, wherein the generator is configured to print the gustatory substance on the carrier element using ink-jet printing or thermal sublimation printing, 3D printing, micro spraying, or mechanical deposition.

18. The method according to claim 12, wherein the generator is configured to activate at least part of the gustatory substances predefined on the carrier element for generating the gustatory product.

19. The method according to claim 12, wherein the generator is configured to remove at least part of the gustatory substances predefined on the carrier element for generating the gustatory product.

20. The system of claim 1, wherein the carrier elements are eatable.
